(19) United States
(12) Patent Application Publication
(10) Pub. No.: US 2008/0012829 A1
(43) Pub. Date: Jan. 17, 2008

(54) Device for Controlling a Computer Mouse-Type Cursor

(76) Inventors: Vitaliy Bardachenko, Kiev (UA); Andrei Bardachenko, Kiev (UA); Alexandr Kariman, Donetsk (UA); Alexandr Rashkevich, Kiev (UA); Ivan Sergienko, Kiev (UA)

Correspondence Address: SHERIDAN ROSS PC, 1560 BROADWAY, SUITE 1200, DENVER, CO, 80202, US

(21) Appl. No.: 10/570,480

(22) PCT Filed: Sep. 28, 2004
(86) PCT No.: PCT/UA04/00069

§ 371 Date: Jul. 11, 2007

(30) Foreign Application Priority Data
Nov. 2, 1997 (RU) 97102215

(51) Int. Cl. G06F 3/033; G06F 21/00

(52) U.S. Cl. 345/167

(57) ABSTRACT

The inventive device for controlling a computer mouse-type cursor relates to computer engineering and consists of a unit for reading out an identifier coding data, a mouse controller and control keys connected to the first and second outputs thereof. Said read out unit is provided with a channel for a multicoordinate identifier. The device is provided with a control key for code reading connected to the third output of the mouse controller and to an additional controller which is connected to the read out unit and to the thirst and second controller outputs and comprises a serially connected sequential code-to-signal converter, storage unit, code readout unit and a decoder. The control input of the code readout unit is connected to the third output of the mouse controller and the control output thereof is connected to the control input of the storage unit, all said keys being connected to a power source. Said invention simplifies the structural design of the device and a software packet for user identification, ensures a sufficiently reliable protection against non-authorised access and increases the mouse multifunctionality.

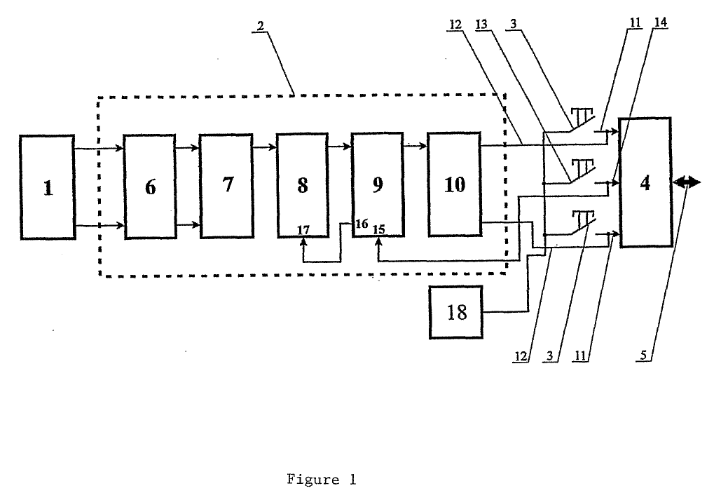

### THE ENGINEERING BRANCH

The invention relates to computer engineering, namely to devices for the computer cursor control.

### PRECEDING ENGINEERING LEVEL

The computer control device is known, Russian application No. 97102215 of Feb. 11, 1997, Cl. G09G 03/02 including the trackball of the cursor position at the display screen, having the cursor coordinates generators. The nonavailability of this device consists in the absence in it the of the user's identification elements which reduces the level of protecting the computer data base against the unauthorized access. This is explained with the fact that protection of the database using special passwords, entered directly to computer, is not always efficient. The other “mouse” type device for computer cursor control is known, including the elements of user's identification in form of the block of readout the identifier code information, controller of “the mouse” trackball, and “the mouse” control buttons connected to it (U.S. Pat. No. 6,337,919 of Jan. 08, 2002, Cl. G06 K 9/00)—the invention prototype. At that, the user's finger serves as identifier. Information on the skin pattern printed from the finger, is transmitted to computer to be compared and analyzed.

This device has several defects too:
1) utilizing the user's finger as identifier shall complicate the range of the device and computer systems: generators (sensors) of the block of readout the code information, mechanical part of this block, because pattering the finger information is made during the movement (pushing) of the control button, of the transducer of information pulses to the code, the software etc.;
2) all the code information, received from the finger, is supplied to computer at the same time though it is known that the computer networks are not sufficiently protected against “burglars”, named the hackers;
3) the danger of the secret taking off the user's fingerprints and producing the moulage-identifier is always present.

Thus, the known device is complicated, and cannot provide sufficient protection against unauthorized access.

### OPENING THE INVENTION

The purpose of this invention consists in producing the improved device for computer cursor (“the mouse”) control due to the fact that the readout block is executed with a channel provided to multicoordinate identifier, the device has the control button to issue the code, connected to the trackball controller lead, and additional controller, connected to the readout block and leads of controller of the trackball to connect “the mouse” control buttons, and including the serially connected signals transducer to the serial code, the memory block, block of the code issue and decoder, at that the control input of the block of the code issue is connected to the trackball of controller output to connect the control buttons of the code issue, and the control output—to the memory block control input, and all the foregoing buttons are connected to the power source. This shall simplify the construction of the device and content of the software package to provide the user's identification at the simultaneous provision of sufficiently efficient protection against unauthorized access, and increase of multifunctionality of “the mouse”.

This is realized due to the fact that the invention, having the above named signs of the prototype, in contrast to it, provides the execution of the readout block with a channel for identifier, and the number of its readout elements, both with the outputs, corresponds to the number of the identifier code coordinates, the device is provided with the control button of the code issue, connected to the output of “the mouse” controller trackball, and additional controller, connected by the inputs to the outputs of the readout block, and by the outputs—to the leads of controller of “the mouse” trackball to put on “the mouse” control buttons, and connecting serially the connected signals transducer to serial code, memory block, block of the code issue, and decoder, which outputs are the outputs of the said controller, and by the number correspond to the number of “the mouse” control buttons, at that the control input of the block of the code issue is connected to “the mouse” trackball controller to put on the control button of the code issue, and the control output—to the control input of the memory block, and all the named buttons are connected to the power source.

Execution of the readout block with the channel for identifier gives a possibility to utilize the key type identifier, which shall simplify the readout block construction and components of the software package to compare and to analyze the code information of the identifier.

At the same time the execution of the readout block with the number of its readout elements and the outputs correspond to the number of the identifier code coordinates (tracks), permits to use the multicoordinate identifiers having increased code characteristics. Utilization of these identifiers with accessory code (f.e. identifier (see RF Patent No. 2097519 of Sep. 09, 1994, Cl. E05B 19/18, and Patent of Ukraine No. 85 to the utility model of Oct. 31, 1997, Cl. G06K 19/06) shall increase the object protection level against the unauthorized access. Using the additional controller connected to “the mouse” trackball controller's leads gives a possibility to utilize the trackball's standard controller with the control buttons connected to it, which shall simplify its construction. At the same time, it increases the device multifunctionality because the control buttons are utilized as the service buttons to realize the functions of “the mouse”, and to eventual manual code composition, which will be explained later.

The above named relation between the signals transducer to the serial code, the memory and key issue blocks, and also relation of the latter and of the control button of the code issue between them and “the mouse” trackball controller makes possible to transform and to store in the computer memory only a part of the identifier code up to the moment of performing the user's identification according to the full code which will increase the protection level of the computer network against the unauthorized access. To this purpose shall serve connection of the code issue control button to the power source to provide the code issue to computer directly by the operator at the moment suitable to it.

The above particular feature of putting on the outputs of additional controller to the trackball controller gives a possibility to carry out, if necessary, the manual composition of the code increasing the device multifunctionality. Connection of “the mouse” control buttons to the power source shall serve to the same purpose.

Correspondence of the number of decoder outputs to the number of “the mouse” control buttons shall provide the earlier referred device multifunctionality.

The presence of the start block in additional controller, operating before the start of the code information readout, shall serve to increase the device operation reliability.

The essence of invention is explained with the device block-diagram with its main blocks shown.

### VERSION OF THE INVENTION REALIZATION

The invention includes the readout block 1, additional controller 2, connected between them, “the mouse” 3 control buttons, “the mouse” trackball controller 4, connected to computer through the interface 5 (not shown).

The additional controller 2 includes the serially connected start block 6, which inputs are the controller inputs, the transducer of signals to serial code 7, memory block 8, block of the code issue 9, decoder 10, which outputs are the outputs of controller.

The control buttons 3 are connected to the trackball controller 4 through its leads 11. The outputs 12 of decoder 10, provided to transduce the separate part of serial code and equal by number to the number of control buttons, are connected to these leads too.

The device has the control button of the code issue 13 connected to the lead 14 of controller 4. The control input 15 of the block of the code issue 9 is connected to this lead too. The control output 16 of this block is connected to the control input 17 of the memory block 8.

The buttons 3 and 13 are connected to the power source 18; the blocks 6-10 are connected to the power source (not shown).

The readout block 1 represents the case with the key type identifier channel, and readout elements, for ex., in form of optopairs (not shown) which quantity is equal to the number of the code coordinates (the tracks) of identifier (f.e. for identifier [3, 4] the number of such coordinates is equal to two). The number of the outputs of block 1 is also equal to the number of the identifier code coordinates.

The start block 6 is executed on the base of one of the interface circuits, for e. the “I” circuit.

The device is operating as follows.

The information readout process starts at the input of identifier to the channel of the readout block 1. The readout is performed by the code coordinates (tracks) of the identifier, and as a result, the signals of each of the tracks come through their block output 1 to additional controller 2: the inputs of its start block 6. At that, at first the information not related to the code is readout from the end of identifier (at using the above identifier—of its silent end in form of two signals of one sound). These signals reduce the start block 6 to the wait condition.

As the identifier is introduced, the code information is entered through the block 6 to the block 7 where it is transformed to serial code entering to the memory block 8. Further passage of the pulses of serial code is provided at operation of the block of the code issue 9, influenced by the control signal, passing through the circuit: lead 14—input 15 of the block 9—its output 16—input 17 of the memory block 8. From the block 8 through the block 9 the serial code enters to the decoder 10 where it is decomposed to the separate parts, the number of which is equal to the number of control buttons 3, and accordingly, to the number of the outputs of decoder 10. F.e., in case of utilization of the named identifier [3, 4] this number is equal to 2, at that the decomposition of the codes is performed on the parts of one character (according to the view of the mark of identifier—conventionally 00000 . . . or 11111 . . . ).

After the decoder the code parts enter to computer through the controller 4 and interface 5 where they are retransformed to the serial code.

The above named control signal comes to the block 9 from the computer or from the power source 18 at pushing the button 13. The code entered to computer is a part of the code used to the user's identification. So, in the event when the hacker got in the computer database with the purpose to remove the user's code, he could not utilize “the mouse” to read out the data from computer.

The entire code of the user is entered to computer on the following stages of identification.

Putting on the rest of the code part is made, f.e., by way of repeated putting on the identifier to the readout block 1. At that, the processing and converting the code information is performed analogically to the above described with the difference only that the control signal is put on to the block of the code issue 9 directly before the moment of definition of the right to the user's access. In case of the extraordinary situations (instructions of different instances, etc.) it is expedient to enter manually the rest of the code part using the button 13.

As a result, the sample of the entire identifier code is entered to computer. To access to computer network the user is to perform the procedure of identification of his right to such access. It is also performed by entering to computer the entire code of his identifier analogically to the above described one. The sample code and the user's code are compared in the computer, and then the user receives access or is rejected to using the computer network.

If necessary (loss or damage of identifier) the user has right to compose the code directly with the control buttons 3.

It is expedient to utilize the invention using standard devices—“the mouse” and type blocks, it can be used in all the economy spheres where the electronic computational facilities are utilized.

1. Device for computer cursor control of “the mouse” type, including elements of the user's identification in form of the block of readout code information of identifier, “the mouse” trackball controller and “the mouse” control buttons connected to it, differing by the fact that the readout block is executed with a channel provided to identifier, and the number of its readout elements, both with the outputs, is conform to the number of the identifier code coordinates, the device is provided with the control button of the code issue, connected to “the mouse” trackball controller's output, and additional controller, connected by its inputs to the outputs of the readout block, and by its outputs—to the leads of “the mouse” trackball controller to connect “the mouse” control buttons, and connecting serially connected to sequent code the signals' transducer, the memory block, block of the code issue, and decoder which outputs are the outputs of this controller, and by its number correspond to the number of “the mouse” control button, at that the control input of the code issue block is connected to “the mouse” trackball controller output to connect the control button of the code issue, and the control output—to the control input of the memory block, and all the named buttons are connected to the power source.

2. Device according to p. 1 differing by the fact that the additional controller includes the start block, operating before the start of the identifier code information readout, and its inputs are the outputs of the named controller, and the outputs are connected to the inputs of the signals transducer to the serial code.
